(19) United States
(12) Patent Application Publication
(10) Pub. No.: US 2026/0287611 A1
(43) Pub. Date: Sep. 24, 2026

(54) MULTI-PROBE ATOMIC FORCE MICROSCOPY ROTATOR

(71) Applicant: Laser Thermal Analysis, Inc., Charlottesville, VA (US)

(72) Inventors: Max Lancaster, Charlottesville, VA (US); Nathaniel Shurack, Louisa, VA (US); Jackson Collins, Charlottesville, VA (US); Brian M. Foley, Charlottesville, VA (US)

(73) Assignee: Laser Thermal Analysis, Inc., Charlottesville, VA (US)

(21) Appl. No.: 19/571,870

(22) Filed: Mar. 19, 2026

Related U.S. Application Data
(60) Provisional application No. 63/775,706, filed on Mar. 21, 2025.

(51) Int. Cl. G01Q 60/38; G01Q 10/04; G01Q 70/06

(52) U.S. Cl. CPC G01Q 60/38; G01Q 10/04; G01Q 70/06

(57) ABSTRACT

Systems and methods for providing a plurality of atomic force microscopy (AFM) probes are disclosed. An exemplary system includes a rotator configured to rotate about an axis. A plurality of AFM probes are disposed on a periphery of the rotator. The plurality of AFM probes may include one or more pluralities of AFM probes that are substantially analogous to one another or that are substantially different from one another. The rotator may be configured to rotate the AFM probes to a specified angle such that a first probe of the plurality of probes overlaps with a sample disposed on a sample holder. The sample holder is configured to translate the sample in three dimensions such that the sample interfaces with the first probe. The first probe is used to map the surface of the sample.

### CROSS-REFERENCE TO RELATED APPLICATION(S)

This application claims the priority benefit, under 35 U.S.C. 119(e), of U.S. Application No. 63/775,706, filed on Mar. 21, 2025, which is incorporated herein by reference in its entirety for all purposes.

### BACKGROUND

Atomic force microscopy (AFM) is a type of scanning probe microscopy (SPM) enabling high-resolution imaging of sample surfaces at scales that traditional optical microscopy is not able to measure due to diffraction limits of visible light. Traditional AFM systems operate by bringing a probe tip near or on a sample surface while moving the sample both vertically and laterally. As the probe tip moves from one spot to another on the sample surface, undulations of the sample surface cause the probe tip to move up and down with the surface profile. Laser light shines on a cantilever to which the tip is mounted, and the cantilever reflects the laser light towards a detector. As the probe moves up and down along the surface of the sample, the laser light is reflected onto different portions of the detector. The fractional illumination of these different portions can be calibrated to AFM probe deflections, and the surface of the sample mapped accordingly.

Different probe tips may vary in shape, size, sharpness, and other features, which enable the mapping of a variety of surface characteristics of a sample that may not be mappable using a single probe tip. However, traditional methods of changing from one probe to another are time consuming. For example, some samples may be placed in a vacuum or under low pressure (e.g., in systems combining AFM with scanning electron microscopy (SEM) or other imaging techniques), and changing AFM probes may require breaking vacuum/repressurizing a sample chamber, manually swapping AFM probes, re-exposing the sample to vacuum, calibrating the new AFM probe, and finally measuring the sample surface with the new probe. This process is time consuming and increases a risk of damaging samples.

### SUMMARY

The present technology is directed toward systems and methods for providing a plurality of AFM probes for characterizing a sample surface, and enables AFM probes to be swapped without removing the tip holder assembly and/or sample being measured from an AFM device.

In an aspect, a system for providing swappable probe tips is provided. The system may include a rotator having a plurality of mounting points for AFM probes. A plurality of AFM probes, which may have different characteristics (e.g., cantilever stiffness, tip radius, conformal coating, etc.) or may include redundant copies of one another, are attached to respective mounting points on the rotator. The rotator may then be oriented such that a sample may be positioned in/near contact with an AFM probe on the rotator and moved such that the surface of the sample is mapped by the AFM probe. The sample may then be moved away from the rotator and the rotator is rotated to bring another AFM probe into a position where it may interface with the sample once the sample is moved back into a corresponding position.

An exemplary rotator in accordance with the present technology may have any suitable number of mounting points such as five mounting points, six mounting points, ten mounting points, 12 mounting points, and so on. The plurality of AFM probes attached to the rotator may include a group of different AFM probes, or may include a plurality of similar or same AFM probes, e.g., for redundancy in the event that an AFM probe breaks during a measurement.

A rotator in accordance with the present technology may be a “barrel” type rotator, where the plurality of AFM probes are parallel with or angled at less than 45° to a central axis of rotation of the rotator, for example, as illustrated in FIG. 1D. Alternatively, a “turret” type rotator may have a plurality of AFM probes that are attached around a periphery of the rotator at a probe angle exceeding 45° to a central axis of rotation of the rotator, for example, as illustrated in FIG. 1A.

Both mounts are rotatable in order to enable a plurality of AFM probes to be used to measure a sample surface without manually installing new AFM probes or removing the sample from an AFM device. In an aspect, the AFM probes may rotate through a plane that is parallel to at least a portion of a sample surface. A sample holder (e.g., a stage) may raise and lower a sample into contact with an AFM probe once the rotator has positioned the AFM probe accordingly.

In some aspects, the techniques described herein relate to a system for scanning probe microscopy (SPM) of a sample, the system including: a rotator configured to rotate about a first axis; a plurality of probes disposed on the rotator; and a sample holder configured to translate a sample along a second axis so as to interface a first probe of the plurality of probes with a surface of the sample when the rotator is rotated to a first position to overlap the first probe with the sample.

In some aspects, the techniques described herein relate to a system, wherein the plurality of probes is disposed on a periphery of the rotator.

In some aspects, the techniques described herein relate to a system, wherein the first axis is substantially perpendicular to the surface of the sample holder.

In some aspects, the techniques described herein relate to a system, wherein the first axis is angled with respect to the surface of the sample holder.

In some aspects, the techniques described herein relate to a system, wherein the first axis is substantially parallel to the surface of the sample holder.

In some aspects, the techniques described herein relate to a system, wherein a second probe of the plurality of probes overlaps the sample when the rotator is rotated to a second position.

In some aspects, the techniques described herein relate to a system, wherein the plurality of probes includes at least five probes.

In some aspects, the techniques described herein relate to a system, wherein the plurality of probes includes at least ten probes.

In some aspects, the techniques described herein relate to a system, wherein the plurality of probes have a plurality of different probe tip characteristics.

In some aspects, the techniques described herein relate to a system, wherein two or more of the plurality of probes include the same probe tip characteristics.

In some aspects, the techniques described herein relate to a system, further including at least one sensor or thermal element disposed on the rotator.

In some aspects, the techniques described herein relate to a system, wherein the sensor includes a temperature sensor.

In some aspects, the techniques described herein relate to a method for scanning probe microscopy (SPM), the method including: rotating a plurality of probes about a first axis of a rotator, the probes disposed on the rotator; translating, using a sample holder, a sample along a second axis until the sample interfaces with the first probe; and mapping a surface of the sample using the first probe.

In some aspects, the techniques described herein relate to a method, further including: translating the sample along the second axis away from the surface of the sample from the first probe; rotating the plurality of probes about the first axis of the rotator until a second probe of the plurality of probes is positioned to interface with the sample and wherein the second probe of the plurality of probes is aligned with the second axis at a second rotational position of the rotator; translating the sample along the second axis toward the second probe of the plurality of probes until the sample interfaces with the second probe; and mapping the surface of the sample using the second probe.

In some aspects, the techniques described herein relate to a method, wherein the first axis is substantially perpendicular to a surface of the sample holder.

In some aspects, the techniques described herein relate to a method, wherein the first axis is angled with respect to a surface of the sample holder.

In some aspects, the techniques described herein relate to a method, wherein the first axis is substantially parallel to a surface of the sample holder.

In some aspects, the techniques described herein relate to a method, wherein the plurality of probes includes at least five probes.

In some aspects, the techniques described herein relate to a method, wherein the plurality of probes includes at least ten probes.

In some aspects, the techniques described herein relate to a method, wherein the plurality probes have a plurality of different probe tip characteristics.

In some aspects, the techniques described herein relate to a method, wherein two or more of the plurality of probes include the same probe tip characteristics.

In some aspects, the techniques described herein relate to a method, further including altering a temperature of the rotator or the sample at least one of thermoelectrically, resistively, or optically.

In some aspects, the techniques described herein relate to a method, further including measuring, using a temperature sensor, a temperature of the rotator.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIGS. 1A-1C illustrate an exemplary system for atomic force microscopy (AFM) having a turret-type rotator in various configurations in accordance with the present technology.

FIG. 2A shows a bottom view of a rotator with twelve probe mounts disposed about a periphery of the rotator.

FIG. 2B illustrates details of a probe slot of one of the probe mounts on the rotator of FIG. 2A.

FIG. 2C illustrates exemplary, non-limiting dimensions of a probe mount of the rotator of FIG. 2A.

FIG. 2D illustrates a top-down view of the rotator of FIG. 2A.

FIG. 2E illustrates a cross-sectional view of the rotator shown in FIG. 2D along line A-A.

FIG. 2F illustrates a side (non-cutaway) view of the rotator of FIG. 2A.

FIG. 2G illustrates a top-down view of the rotator of FIG. 2A.

FIG. 2H shows a probe mount having a mounting angle for a probe tip of approximately 13°from the top surface of the rotator.

FIG. 2I illustrates an isometric view of the 12-probe rotator in accordance with the present technology.

FIG. 3A shows a 12-probe rotator having three probes attached to various probe mounts of the rotator.

FIGS. 3B and 3C illustrate isometric views of the 12-probe rotator, including probe mounts with attached AFM probes.

FIG. 3D shows a 12-probe rotator attached to a rotational mechanism and controller.

FIG. 4A shows a side view of a six-probe rotator in accordance with the present technology.

FIG. 4B shows a bottom view of the six-probe rotator of FIG. 4A.

FIG. 4C illustrates a probe mount that may be utilized in accordance with a six-probe rotator.

FIGS. 4D and 4E show two different side views of the six-probe rotator of FIG. 4A including angled surfaces of the probe mount for securing AFM probes to the rotator.

FIG. 5A shows a six-probe rotator mounted on a rotational mechanism and controller.

FIG. 5B illustrates the six-probe rotator detached from the rotational mechanism and controller.

FIG. 5C illustrates a closeup view of a probe mount with attached AFM probe of the six-probe rotator.

FIG. 5D shows the underside of a six-probe rotator with a ring-shaped thermoelectric cooler (TEC), also known as a Peltier module, for heating and/or cooling the six-probe rotator and the attached AFM probes.

FIG. 5E shows the six-probe rotator of FIG. 5D with a thermistor-based temperature sensor on its upper side for measuring the temperature of the six-probe rotator and the attached AFM probes.

FIGS. 6A-6C illustrate a tip spring suitable for mounting an AFM probe to the probe mount of an inventive rotator along with exemplary, non-limiting dimensions in inches.

FIG. 7 illustrates an AFM system with a barrel rotator.

FIGS. 8A-8C illustrate a barrel rotator in accordance with the present technology.

FIG. 8D illustrates a barrel rotator positioned relative to a sample on a sample holder.

FIG. 9 shows examples of AFM probes suitable for mounting to an inventive AFM probe rotator.

### DETAILED DESCRIPTION

Atomic force microscopy (AFM) enables sub-micron resolution imaging and topology mapping of objects using an AFM probe moved across a surface of a sample (equivalently, the probe may be held in place while the sample is moved underneath it). An AFM system may bring a cantilevered probe tip in contact with the sample surface as the sample is moved using one or more very precise mechanisms such as piezoelectric elements. AFM systems may be used for force spectroscopy, e.g., to characterize properties of a sample such as Young's modulus. AFM systems are also used for topological mapping of a sample by moving the sample relative to the probe while the probe is in contact with the surface. When the probe is deflected by deviations in the surface, a laser or other means may be used to measure the deflection by reflecting light from the probe and detecting how much the reflection is altered by the deflection of the probe.

### AFM Systems With Turret Rotators

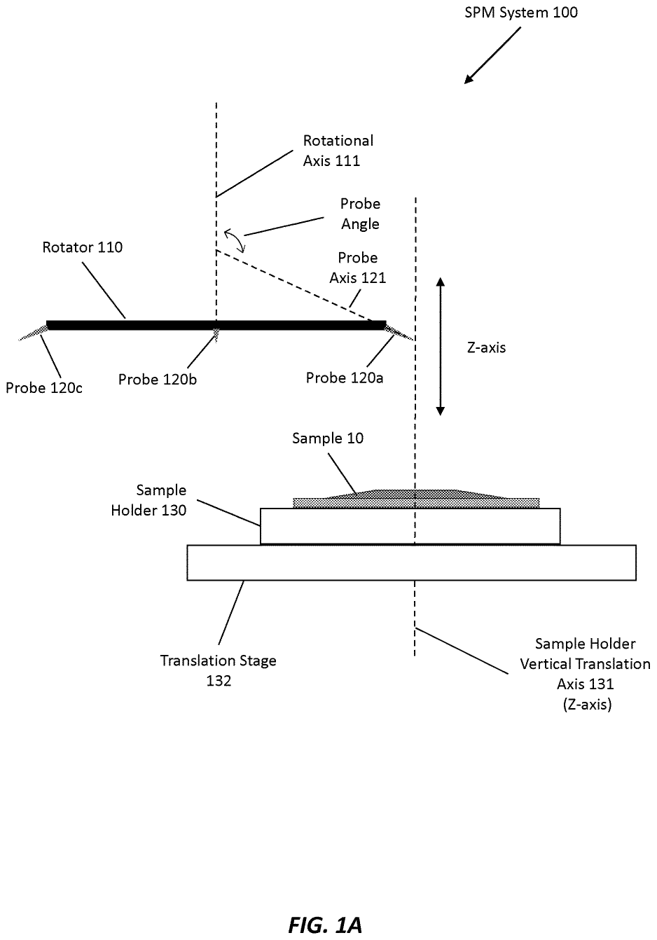

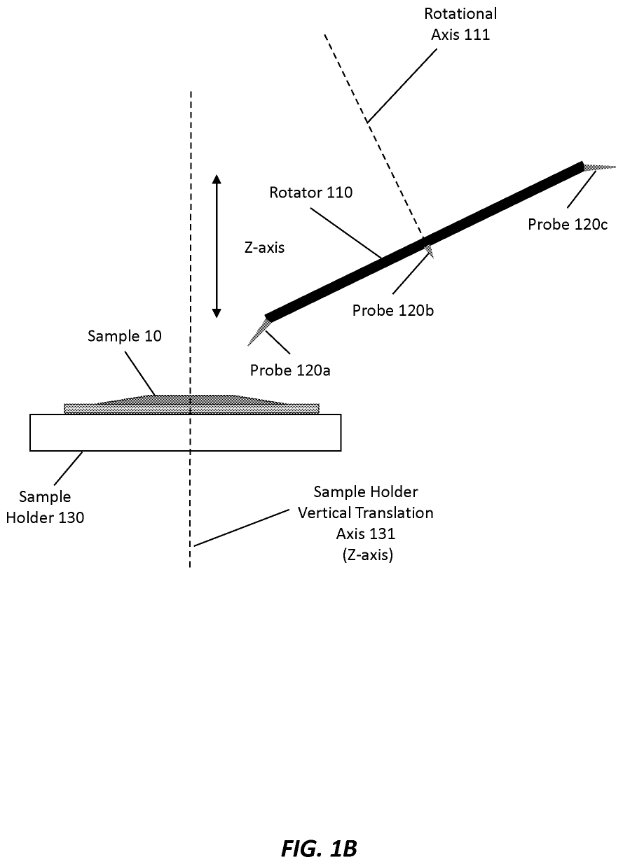

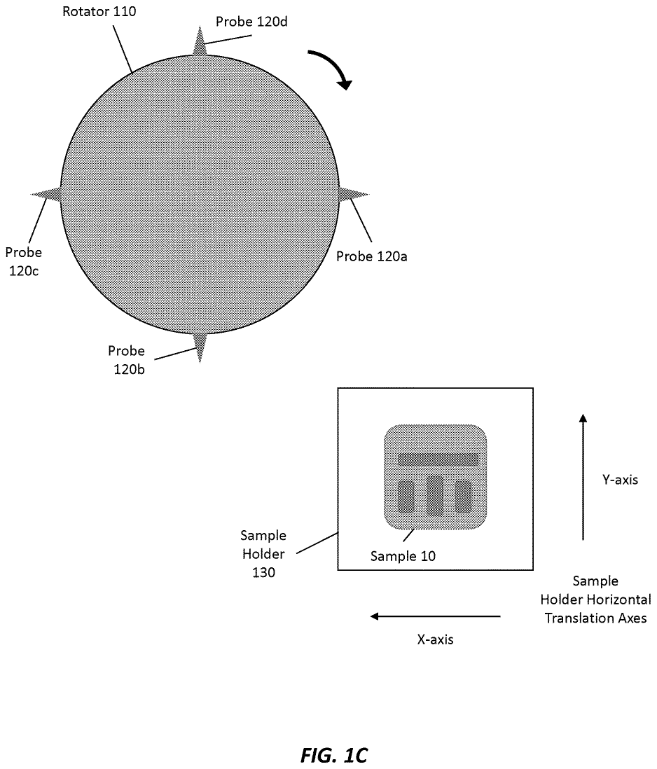

FIGS. 1A-1C illustrate an exemplary AFM system 100 in accordance with the present technology. The system 100 of FIGS. 1A-1C includes a turret-style rotator 110 (also called a turret rotator or rotor) having a plurality of AFM probes 120a-120d (called probes 120 for short) disposed thereon. In an aspect, the AFM probes 120 may be disposed around a periphery of the rotator 110, e.g., as shown in FIG. 1C. The rotator 110 is configured to rotate about an axis, shown as the rotational axis 111 in FIGS. 1A and 1B. The rotator 110 may be rotated to an angle or range of angles to allow a first probe 120a to interface with a sample 10 that is positioned appropriately with a sample holder 130. Interfacing with an object may include directly contacting or touching the object with the probe or bring the probe close enough to an object such that the probe is affected by atomic forces of atoms/molecules that make up the object even if not in direct contact. For example, a probe may be brought to a standoff distance d at which the probe is deflected and/or a vibrational frequency of the probe is changed due to atomic forces.

A rotator 110 in accordance with the present technology may include any suitable number of probes 120, including two, three, four, five, six, eight, ten, 12, 18, 20 probes 120, or the like. The rotational axis 111 may be aligned with the gravity vector (i.e., be substantially vertical) as shown in FIG. 1A or may be disposed at an angle with respect to the gravity vector as shown in FIG. 1B. Each probe 120 may translate through a plane when the rotator 110 is rotated, e.g., through a horizontal plane that may be substantially parallel to a surface of the sample 10 or at an angle with respect to the surface of the sample 10.

The system 100 of FIGS. 1A-1C may further include a sample holder 130 configured to hold the sample for mapping using the AFM probes. The sample holder 130 may be configured to translate in three dimensions, including along a vertical axis, for example, thanks to a multi-axis translation stage 140 or other actuator(s). When the sample holder 130 is translated along the vertical axis, the sample 10 may interface with one of the probes 120. Each probe 120 may be characterized by a probe axis 121, which may form a probe angle with respect to the rotational axis 111 of the rotator 120. As illustrated in FIG. 1A, the probe angle may be greater than 45°.

The rotator 110 may be rotated to position one of the probes 120 (e.g., probe 120a) above the sample 10 on the sample holder 130. The rotator 110 can then be lowered or tilted and/or the sample 10 and sample holder 130 may then be raised until the sample 10 interfaces with the probe 120a (until the sample 10 touches the probe 120a and/or causes the probe 120a to deflect). The sample holder 130 may then translate along a second and/or third (horizontal) axis to enable a mapping of a surface of the sample 10, as well as tip or tilt (e.g., an orientation with respect to all three Cartesian coordinates may be altered) in three dimensions. For example, each sample holder axis of translation may be described by Cartesian coordinates having three orthogonal axes. The sample holder vertical translation axis may be defined as the “z-axis,” while the “x-axis” and “y-axis” may be orthogonal to the z-axis and in a horizontal plane. The sample holder 130 can hold the sample 10 such that a surface of the sample 10 is perpendicular to the rotational axis 111 of the rotator 110, e.g., as in FIG. 1A. Additionally or alternatively, the sample holder 130 can hold the sample 10 such that a surface of the sample 10 is angled with respect to the rotational axis 111 of the rotator 110, e.g., as in FIG. 1B.

The sample holder 130 and stage 140 may accordingly translate the sample 10 in three dimensions while the surface of the sample 10 is in contact with the probe 120a, thus mapping or characterizing the surface. Additionally or alternatively, the probe 120a may be used to characterize the sample 10 by translating the sample 10 in the z-axis until the probe 120a contacts the surface of the sample 10. The sample 10 may then be translated further in the z-axis, and a deflection of the probe 120a may be measured and correlated to a force acting on the probe 120a. A surface hardness, Young's modulus, or other characteristic of the sample 10 may be determined from the measured probe deflection.

A second, third, fourth, or subsequent probe 120 may further map the surface of the sample 10. For example, after the surface of the sample 10 is mapped using the first probe 120a, the sample holder 130 and stage 140 may translate the sample 10 along the z-axis away from the first probe 120a to bring the first probe 120a out of contact with the sample 10. The rotator 110 may then rotate about the rotational axis 111 to a second angle such that a second probe 120b overlaps the sample surface. The sample holder 130 and stage 140 may then translate the sample 10 along the z-axis until the surface of the sample 10 is in contact with the second probe 120b. The sample holder 130 and stage 140 may again translate the sample 10 in three dimensions to further map and/or characterize the sample surface with the second probe 120b.

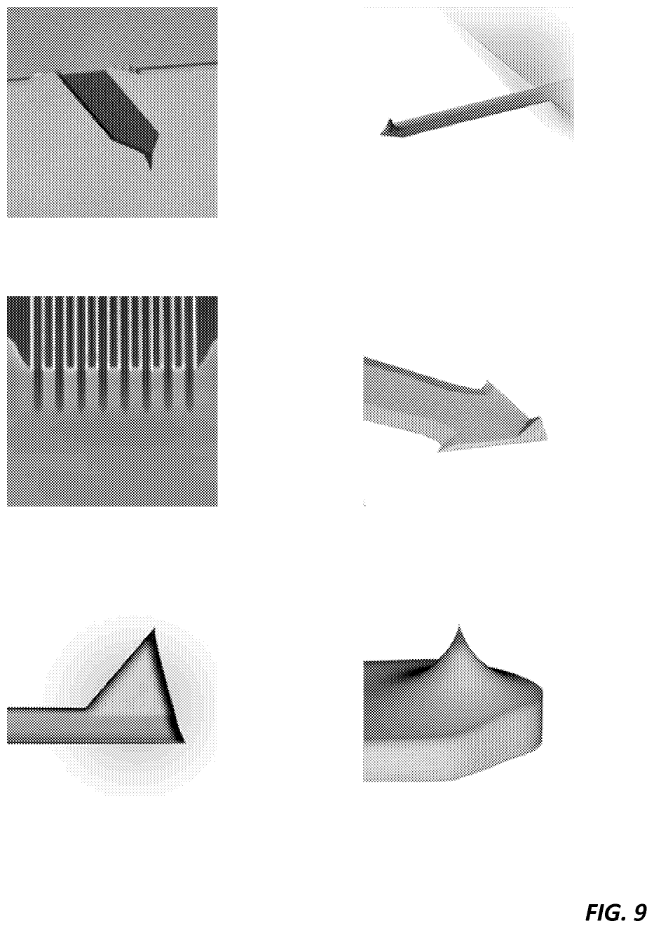

Each of the probes 120 may have different characteristics, or some or all of the probes 120 may share similar characteristics. For example, each probe 120 may have a different cantilever stiffness, resonant frequency, length, width, thickness, coating (such as a conformal coating), tip radius, half cone angle, tilt, aspect ratio, or any suitable characteristic. For example, FIG. 9 shows example AFM probes suitable for mounting to a probe rotator, including (clockwise from upper left): (1) a silicon probe with visible apex tip for soft tapping, force modulation, or bimodal imaging on medium to hard samples; (2) a force modulation probe with an apex sharp conductive single-crystal diamond tip for high-resolution topography and electrical imaging; (3) a silicon probe with a visible tip apex and magnetic coating for magnetic force microscopy; (4) a tapping/ non-contact silicon probe with a gold reflex coating; (5) a silicon probe with a tip at the end of a cantilever and no reflex coating for force modulation microscopy; and (6) a silicon probe with eight arrow-shaped, tipless cantilevers. In an aspect, two or more probes 120 may share some or all characteristics (e.g., be substantially duplicates of one another) such that they may provide redundancy in case one probe 120 breaks or is otherwise damaged.

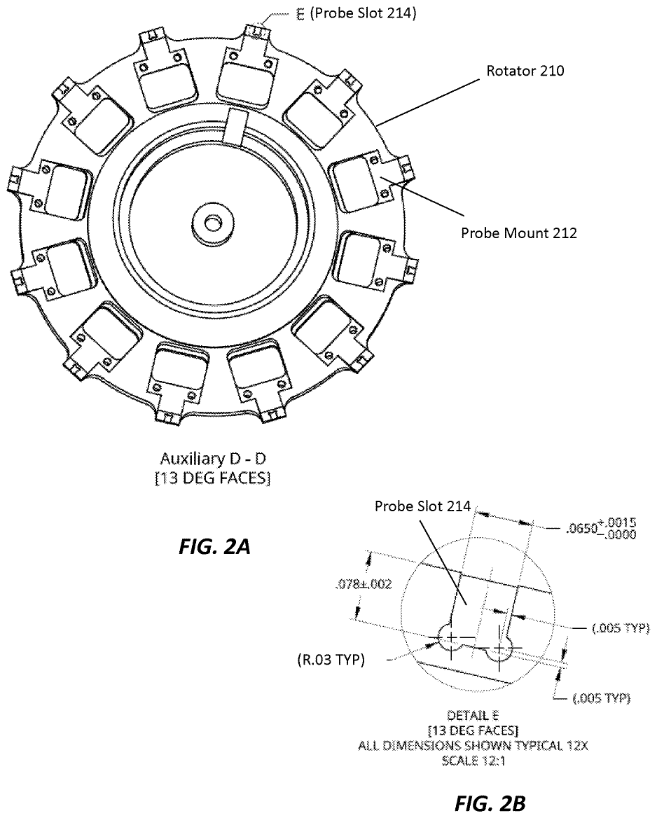

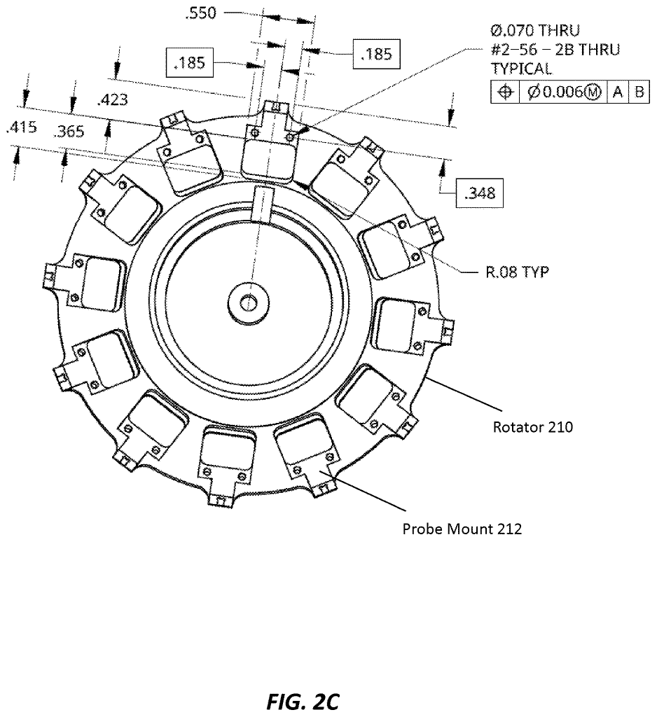

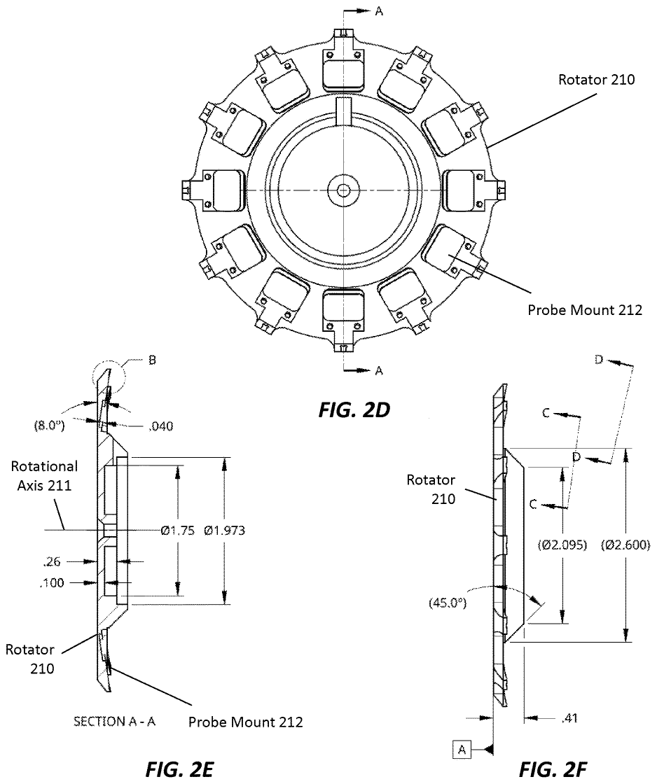

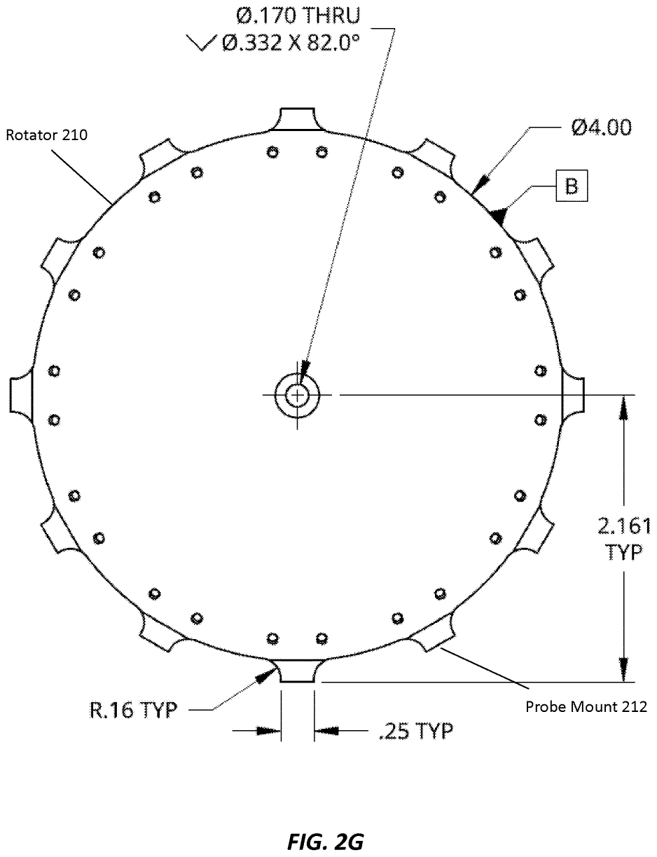

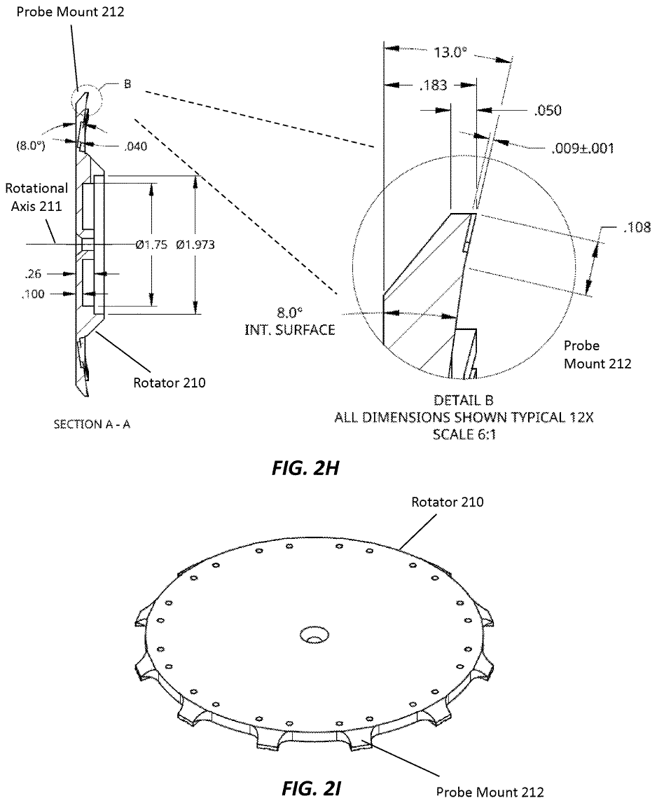

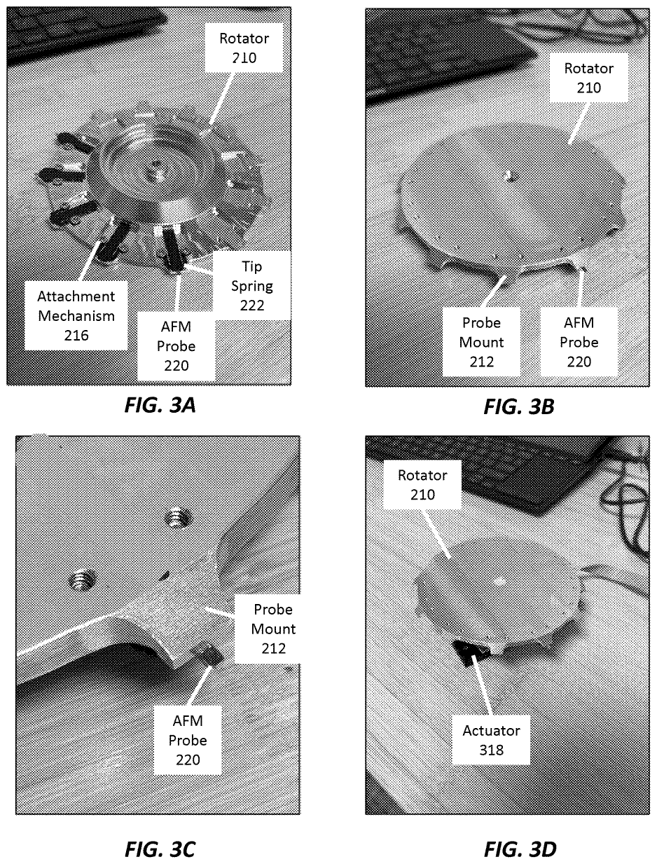

FIGS. 2A-2I illustrate aspects of an example turret-style rotator 210 in accordance with the present technology. FIG. 2A shows a bottom view of the rotator 210, which has 12 probe mounts 212 disposed about its periphery. The probe mounts 210 may be secured to the underside of the rotator 210 through a suitable attachment mechanism 216 (FIG. 3A) such as one or more clamps, screws, pins, epoxies, springs or the like. The probe mounts 212 can also be integrally formed with the rotator 210, e.g., cast with the same mold or machined from the same piece of metal. FIG. 2B (Detail E of FIG. 2A) shows one of the probe slots 212 in greater detail.

FIG. 2B shows a probe slot 214 that is formed in the probe mount 212 to receive a (replaceable, removable) AFM probe 220 (FIG. 3C). The AFM probe 220 slides into the probe slot 214 and can be fixed in place with a fastener, such as a bolt, screw, or spring. A tip spring 222 biases the tip of the AFM probe 220 toward the sample surface, compressing and relaxing with undulations in the sample surface as the tip of the AFM probe 220 is pulled across the sample surface. The AFM probe 220 can be replaced if it breaks or wears out or if a different type of AFM probe is desired for a particular measurement.

FIG. 2B also shows exemplary, non-limiting dimensions of the probe slot 214. An opening of the probe slot 214 may be about 0.065+0.0015/−0.000 inches. The probe slot 214 may have a depth in a radial direction (of the rotator 210) of about 0.078±0.002 inches. The probe slot 214 may additionally include circular cutouts at the inner corners that allow for screws or other attachment mechanisms to hold the probe in the probe slot 214. A center of the circular cutouts may be offset from the walls of the probe slot 214 by a suitable margin, e.g., 0.005 inches.

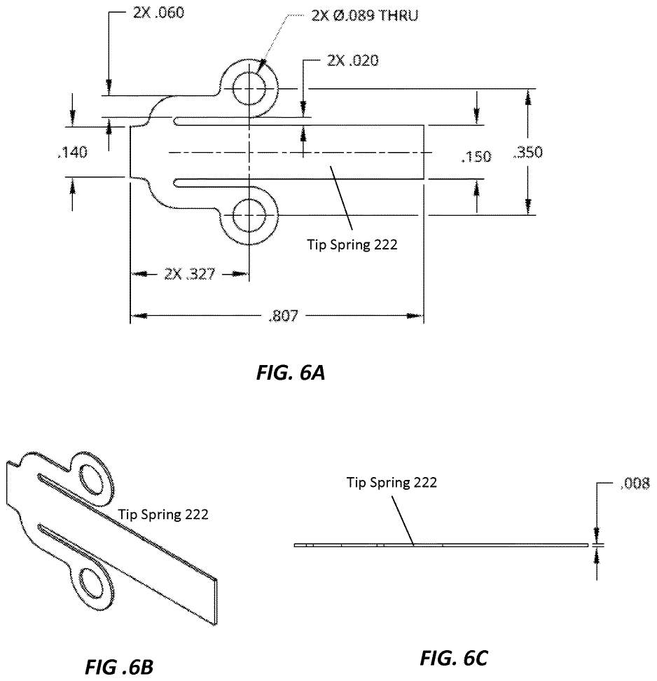

FIG. 2C illustrates exemplary, non-limiting dimensions of the probe mount 212 of the rotator 210. The dimensions illustrate cutouts that are intended for use with a spring-type attachment mechanism where there are two holes for attachment of a spring (see, e.g., FIGS. 6A-6C) and a well across which a long central portion of the spring spans and can be pushed downward via a finger or other force-application mechanism to bend the end of the spring upward and allow loading of the probe into the probe slot 214. The probe mount 212 may include one or more through holes configured to admit an attachment mechanism such as a screw, pin, spring or other suitable mechanism. All dimensions shown are in inches. The probe mounts 212 may be regularly disposed around a periphery of the rotator (e.g., there may be a regular angular and circumferential separation between adjacent probe mounts).

FIG. 2D illustrates a bottom-up view of the rotator 210, which is shown in further cutaway detail in FIGS. 2E and 2F. FIG. 2E illustrates a cross-sectional view of section A-A shown in FIG. 2D and shows tip angles and internal cutouts to facilitate mounting of the rotator 210 to a rotation stage (not shown). A rotational axis 211 of the rotator 210 is shown, as well as exemplary dimensions of channels and other features of the rotator 210.

FIG. 2F illustrates a side (non-cutaway) view of the rotator 210 including corresponding exemplary dimensions of further features of the rotator 210. The dimensions shown include an outer diameter (2.095 in) at the bottom of a 45-degree angle bevel, a diameter of the circle where the 45-degree angle bevel terminates (2.600 in), and the total height (0.41 in) from the top surface of the turret to the bottom surface of the rotator 210.

FIG. 2G illustrates a top-down view of the rotator 210 as well as exemplary, non-limiting dimensions. Each probe mount 212 may be approximately 0.25 inches wide, with a fillet or radial feature of about 0.16 inches. The rotator 210 may have a diameter of about 4 inches, and a dimension from the center of the rotator 210 to an outer edge of a probe mount 212 may be approximately 2.161 inches. The rotator 210 may include a central through hole for mounting the rotator 210 on a rotation stage in a suitable AFM system. The central through hole may have a diameter of approximately 0.170 inches and may be countersunk. The countersink diameter may be approximately 0.332 inches at an angle of approximately 82° from the top plane of the rotator.

FIG. 2H illustrates a cross-sectional view (left) of the rotator 210 along with a close-up (right) of detail view B of a probe mount 212 including exemplary, non-limiting dimensions. FIG. 2H shows the probe mount 212 with a mounting angle of approximately 13° from the top surface of the rotator 210. Any suitable mounting angle is possible, and the mounting angle may indicate an angle of a cantilever of a probe (not shown) relative to the top surface of the rotator 210 (and a surface of a sample 10 or sample holder 130). In an aspect, the top surface of the rotator 210 may be parallel to a surface of the sample 10 or of the sample holder 130. In an aspect, a probe tip may be positioned such that the probe tip is normal to a surface of a sample 10 to be measured.

FIG. 2I illustrates an isometric view of the 12-probe rotator 210. Through holes for securing each probe mount 212 to the rotator 210 are visible, as is a central countersunk through hole for securing the rotator 210 to a rotational mechanism (actuator) in a suitable AFM system.

FIGS. 3A-3D illustrate isometric views of the 12-probe rotator 210 with AFM probes 220 affixed to the probe mounts 212. FIG. 3A shows a tip spring 222 for securing each AFM probe 220 to the rotator 210. The tip spring 222 may be secured to the rotator 210 using any suitable attachment mechanisms such as screws, which are shown in FIG. 3A. An exemplary tip spring 222 is shown in further detail in FIGS. 6A-6C, described below.

FIG. 3A shows the 12-probe rotator 210 with three probes 220 attached to respective probe mounts 212. The probes 220 may be mounted in any suitable position, and symmetry of mounting location is not required. For instance, the probes 220 can be attached to adjacent probe mounts 212, to every other probe mount 212, to every second probe mount 212, to probe mounts 212 on opposite sides of the rotator 210 and so on. More or fewer probes 220 can be attached to the rotator 210, which can accommodate up to one probe 220 per probe mount 212, or up to twelve probes 220 in all.

FIGS. 3B and 3C illustrate isometric views of the 12-probe rotator 210, including probe mounts 212 with attached AFM probes 220. FIG. 3D shows the rotator 210 attached to a rotational actuator 318 and controller. Through holes for exemplary attachment mechanisms (seen in FIG. 3A) used to secure tip springs 222 and/or probes 220 are visible in each of FIGS. 3A-3D.

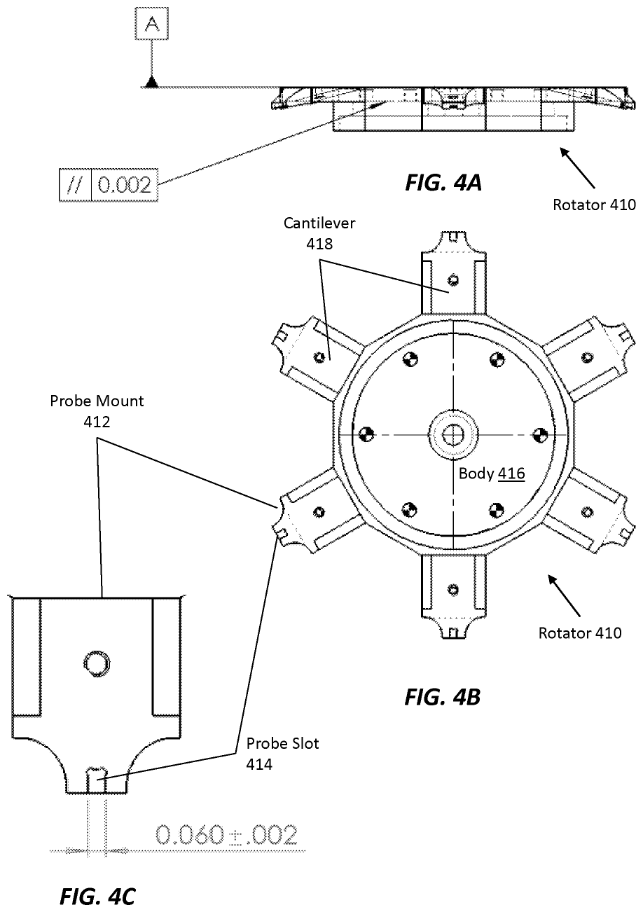

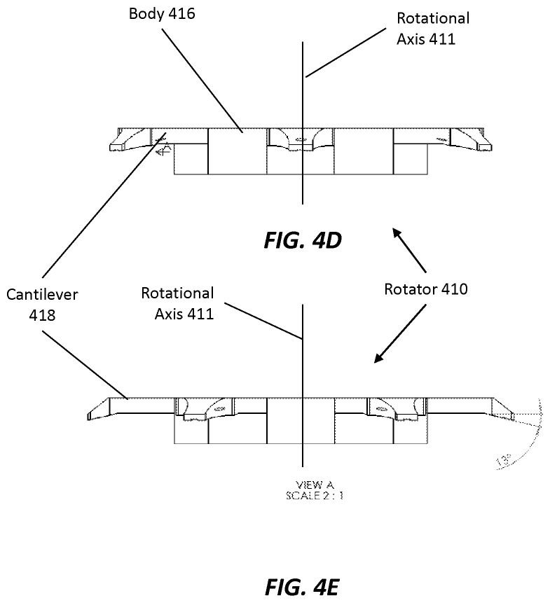

FIGS. 4A-4C illustrate a six-probe rotator 410 suitable for use an AFM system in accordance with the present technology. This rotator 410 includes six probe mounts 412 distributed regularly around the periphery of the rotator 410. In this case, however, the probe mounts 412 are attached to the undersides of cantilevers 418 extending from a circular rotator body 416. The cantilevers 418 can be integral with the body 416 as shown in FIGS. 4A-4C or attached to the body 416 with bolts or other suitable fasteners.

FIGS. 4A and 4B show profile (side) and plan (bottom) views, respectively, of the rotator 410, which may be smaller and more compact than the rotator 210 of FIGS. 2A-2I. FIG. 4C illustrates a probe mount 412 that may be utilized with the rotator 410. The probe mount 412 may include a probe slot 414 analogous to that illustrated in FIG. 2B.

FIGS. 4D and 4E show additional side views of the six-probe rotator 410, including the rotational axis 411 about which the rotator 410 spins or rotates and angled surfaces of the probe mount 412 for securing AFM probes to the rotator 410. As with the 12-probe rotator 210 (FIGS. 2A-2I), the probe mounts 412 having a mounting angle of 13°, though any suitable mounting angle is possible.

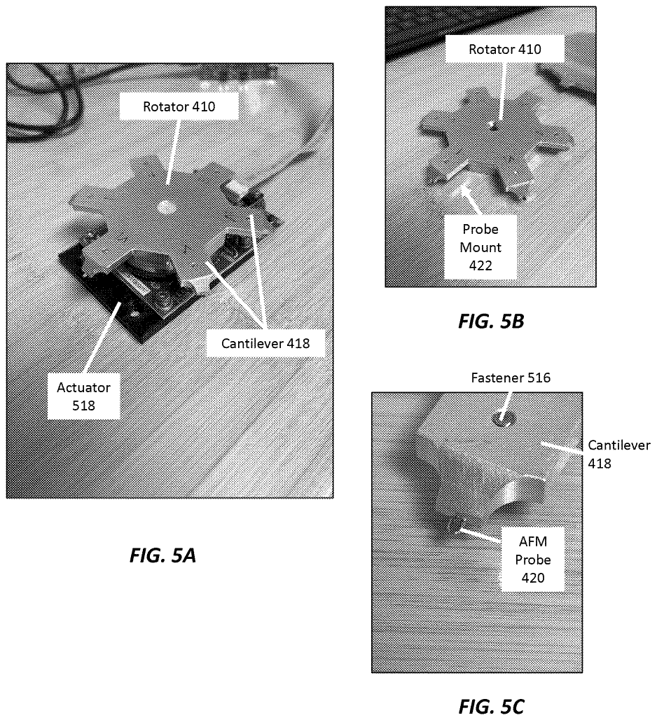

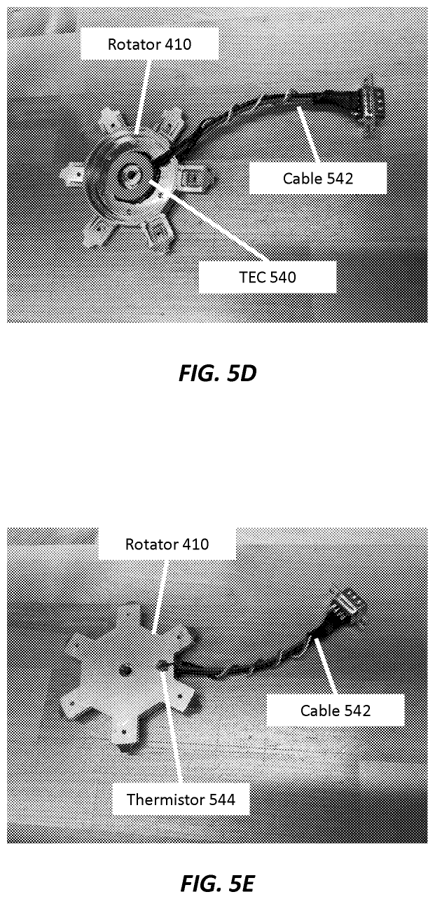

FIGS. 5A-5C show the six-probe rotator 410 fitted with AFM probes 420 and mounted to an exemplary rotational mechanism 518 and controller for controlling an angle of the rotator. The rotational mechanism 518 may include an electric motor or other suitable rotational actuator for spinning the rotator 410 about its rotational axis 411. The controller may include circuitry such as sensors, a processor, and memory that stores instructions for the processor to actuate the rotation mechanism 518 so as to spin the rotator 410 to a specified angle. The angle of the rotator 410 may be chosen to allow a probe 420 to interface with a surface of a sample 10, for example, as illustrated in FIGS. 1A and 1B. In an aspect, the probe mounts of the rotator 410 may be integral with the rotator 410 (e.g., may not be removable).

FIG. 4B illustrates the rotator detached from the rotational mechanism and controller 518. FIG. 4C shows a closeup view of the top side of one cantilever 418 with an AFM probe 420 attached to a probe mount 420 affixed to the bottom side of the cantilever 418. A fastener 516, such as a bolt or screw, extends through a through hole in the cantilever 418 to the attachment mechanism 412 for holding the AFM probe 420 in place. As with the 12-probe rotator 210 (FIGS. 2A-2I), the six-probe rotator 410 may include a plurality of different probes 420, e.g., probes 420 of up to six different types. Additionally or alternatively, the six-probe rotator 410 may include several probes 420 that are the same or similar to one another, e.g., for redundancy.

A rotator in accordance with the present technology, including the six-probe rotator and 12-probe rotator illustrated herein, may include fewer probes than probe mounts. For example, the 12-probe rotator may be used with ten probes, eight probes, two probes, one probe, or any suitable number of probes less than or equal to 12.

### Rotator and/or Probe Temperature Control and Sensing

In an aspect, a rotator may include one or more sensors, heating elements, and/or cooling elements. For example, a rotator may include one or more heating elements disposed on or adjacent to a probe mount to generate heat that is then transferred to a probe attached to the probe mount and from there to a sample, for example, to characterize an aspect of the sample as a function of temperature. An inventive rotator may include one or more temperature sensors (e.g., thermistors, resistive temperature detectors (RTDs), thermocouples, semiconductor integrated circuits, etc.) to monitor the rotator's temperature as one or more probes are heated or cooled using an appropriate thermal element such as one or more heating or cooling elements. Additionally or alternatively, the temperature of the rotator, sample, and/or sample holder may be controlled or altered (e.g., maintained, raised, or lowered) using a thermal element such as a resistive heater, a thermoelectric heater, a Peltier device, an optical heater (e.g., a laser), a heat sink, or any suitable thermal element. This may enable a closed-loop control of probe temperature during experiments or sample measurements.

FIGS. 5D and 5E show the six-probe rotator 410 with thermoelectric cooler (TEC) 540 on its bottom and a thermistor-type temperature sensor 544 on its top for controlling the six-probe rotator's temperature and the temperature of the AFM probes 420 attached to the six-probe rotator 410. A cable 542 connects the TEC 540 and thermistor 544 to a suitable controller and power source (not shown). The TEC 540 is ring-shaped (annular) and is mounted to the inner/bottom surface of the six-probe rotator 410, axially aligned with the rotational axis 411 (FIGS. 4D and 4E). In operation, the TEC 540 heats or cools the six-probe rotator 410 and attached AFM probes 420 while the thermistor-type temperature sensor 544 monitors the temperature, providing feedback to the controller.

Controlling temperature may enable characterization of functional properties of a sample, probe, cantilever, and surface coatings, such as mechanical, optical, thermal properties, as well as set the temperature of the probe and/or cantilever at a fixed value relative to the sample temperature (which may be similarly controlled) to facilitate property measurements of a sample under a thermal gradient between tip and sample.

### Tip Springs for Mounting Probes to Rotators

FIGS. 6A-6C illustrate the tip spring 222 along with exemplary, non-limiting dimensions in inches. The tip spring 222 may stamped, water-jet cut, machined, or manufactured in any other suitable manner. The tip spring 222 may apply a predetermined force to a probe to keep the probe in place during AFM operation. The tip spring 222 may have one or more holes through each of which a suitable attachment mechanism such as a screw or bolt may be disposed in order to secure the tip spring 222 to the rotator (e.g., a turret-style rotator or a barrel-style rotator). The tip spring 222 may be designed (e.g., by using suitable dimensions and/or materials) to allow a user to release clamping pressure securing a probe in place by using their finger or other suitable object, while providing enough of a clamping force to hold the probe in place during AFM measurements.

### AFM Systems With Barrel Rotators

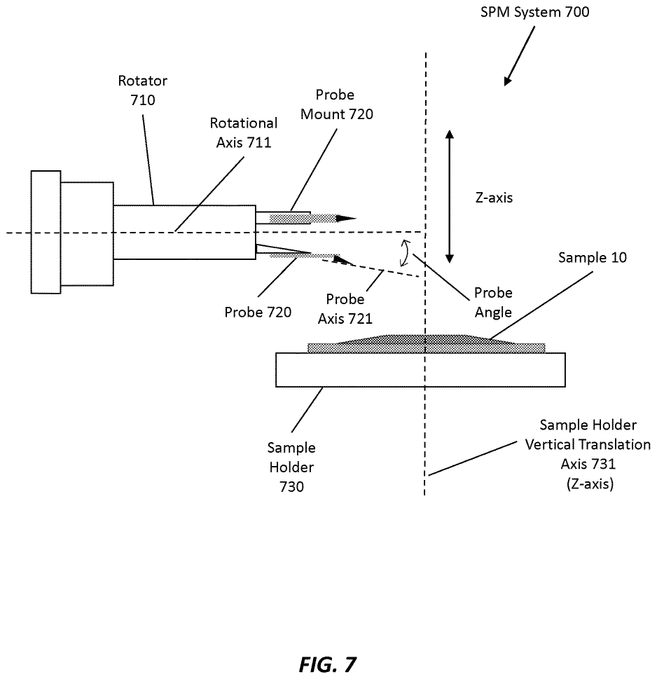

FIG. 7 illustrates an AFM system 700 with a barrel-style rotator or barrel rotator 710. The barrel rotator 710 is configured to rotate about a first axis (a rotational axis 711). This rotational axis 711 may be perpendicular or otherwise angled with respect to a second axis (a sample holder vertical translation axis 731) and therefore parallel or angled with surfaces of a sample holder 730 and of a sample 10 supported by the sample holder 730. The barrel rotator 710 may include a plurality of probe mounts 710, each of which holds a corresponding probes 720 that may be oriented to interface with the surface of the sample 10 when the barrel rotator 710 is rotated about the rotational axis 711 to a specific angle (e.g., 0°, 120°, or 240°for a barrel rotator with three equi-spaced probes 720). Each probe 720 may be characterized by a probe axis 721, which may form a probe angle with respect to the rotational axis 711 of the barrel rotator 710. In an aspect, the probe angle may be less than 45°.

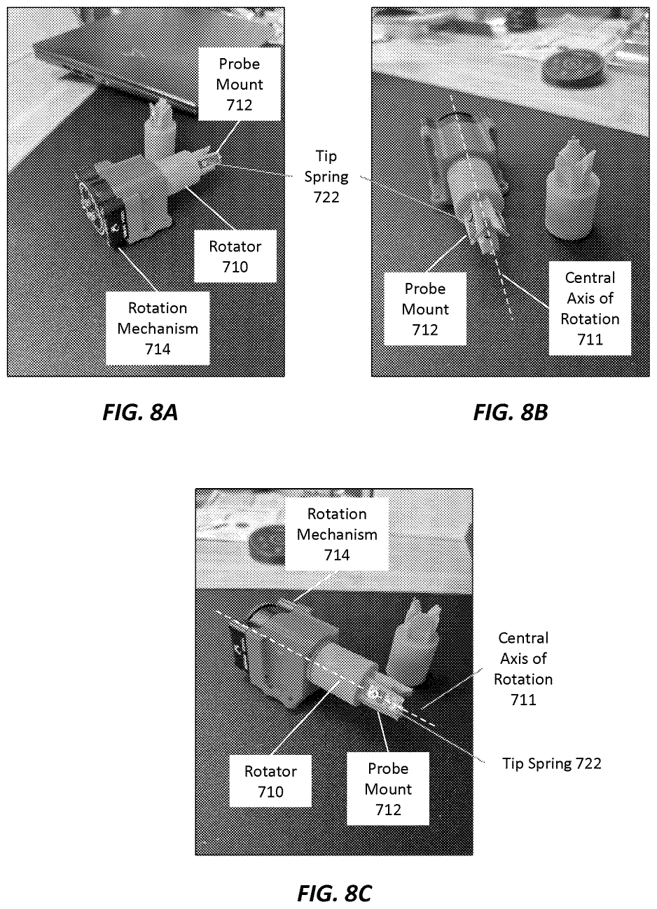

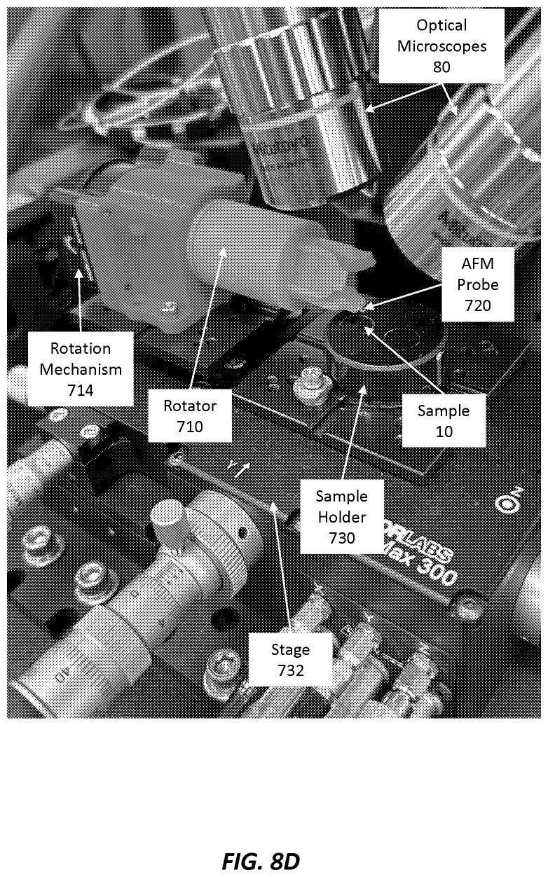

FIGS. 8A-8C illustrate the barrel rotator 710 in accordance with the present technology. The probe mounts 712 are arranged such that the tips of AFM probes 720 attached to the barrel rotator 710 face away from the rotator's rotational axis 711. Tip springs 722 attached to the probe mounts 712 bias the tip of each attached AFM probes 720 towards the sample surface when that AFM probe 720 is rotated into the appropriate position. The rotator 710 may be mechanically coupled to a rotation mechanism 714 such as an electric motor configured to rotate the rotator 710 about the rotational axis 711 to a suitable angle and/or position for interfacing one of the probes 720 with a sample of the surface 10.

The barrel rotator 710 may have an advantage of being more spatially compact than the turret-style rotators 110, 210, and 410 illustrated in FIGS. 1A-5C. Probes 720 attached to a barrel rotator 710 may be spaced more closely together than probes attached to a turret rotator.

FIG. 8D illustrates the barrel rotator 710 positioned adjacent to a sample 10. The sample 10 is disposed on the sample holder 730 and may be viewed through one or more optical microscopes 80, e.g., to determine the position of the tip of an AFM probe 720 relative to a surface of the sample 10. FIG. 8D further shows the rotation mechanism 714 mechanically coupled to the rotator 710 for rotating probes 720 into and out of position. As discussed below, the temperature of the sample holder 730 may be controlled or altered as desired using a suitable thermal element or thermal control mechanism. The sample holder 730 may further be disposed on a stage, which may translate the sample holder 730 and the sample 10 in one, two, or three dimensions.

### Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A system for scanning probe microscopy (SPM) of a sample, the system comprising:
a rotator configured to rotate about a first axis;
a plurality of probes disposed on the rotator; and
a sample holder configured to translate a sample along a second axis so as to interface a first probe of the plurality of probes with a surface of the sample when the rotator is rotated to a first position to overlap the first probe with the sample.

2. The system of claim 1, wherein the plurality of probes is disposed on a periphery of the rotator.

3. The system of claim 1, wherein the first axis is substantially perpendicular to the surface of the sample holder.

4. The system of claim 1, wherein the first axis is angled with respect to the surface of the sample holder.

5. The system of claim 1, wherein the first axis is substantially parallel to the surface of the sample holder.

6. The system of claim 1, wherein a second probe of the plurality of probes overlaps the sample when the rotator is rotated to a second position.

7. The system of claim 1, wherein the plurality of probes comprises at least five probes.

8. The system of claim 1, wherein the plurality of probes comprises at least ten probes.

9. The system of claim 1, wherein the plurality of probes includes probes with different probe tip characteristics.

10. The system of claim 1, wherein two or more probes in the plurality of probes have the same probe tip characteristics.

11. The system of claim 1, further comprising at least one sensor or thermal element disposed on the rotator.

12. The system of claim 11, wherein the sensor comprises a temperature sensor.

13. A method for scanning probe microscopy (SPM), the method comprising:
rotating a plurality of probes about a first axis of a rotator, the probes disposed on the rotator;
translating, using a sample holder, a sample along a second axis until the sample interfaces with the first probe; and
mapping a surface of the sample using the first probe.

14. The method of claim 13, further comprising:
translating the sample along the second axis away from the surface of the sample from the first probe;
rotating the plurality of probes about the first axis of the rotator until a second probe of the plurality of probes is positioned to interface with the sample and wherein the second probe of the plurality of probes is aligned with the second axis at a second rotational position of the rotator;
translating the sample along the second axis toward the second probe of the plurality of probes until the sample interfaces with the second probe; and
mapping the surface of the sample using the second probe.

15. The method of claim 13, wherein the first axis is substantially perpendicular to a surface of the sample holder.

16. The method of claim 13, wherein the first axis is angled with respect to a surface of the sample holder.

17. The method of claim 13, wherein the first axis is substantially parallel to a surface of the sample holder.

18. The method of claim 13, wherein the plurality of probes comprises probes with different probe tip characteristics.

19. The method of claim 13, wherein two or more probes in the plurality of probes have the same probe tip characteristics.

20. The method of claim 13, further comprising varying a temperature of the rotator.
